(19) United States
(12) Patent Application Publication
(10) Pub. No.: US 2026/0150089 A1
(43) Pub. Date: May 28, 2026

(54) SIGNAL TRANSMISSION METHOD, GROUND STATION, GROUND TERMINAL AND STORAGE MEDIUM

(71) Applicant: ZTE CORPORATION, Shenzhen (CN)

(72) Inventors: Kaibo TIAN, Shenzhen (CN); Hehe ZHU, Shenzhen (CN); Binxin YAN, Shenzhen (CN)

(21) Appl. No.: 19/129,926

(22) PCT Filed: Nov. 21, 2023
(86) PCT No.: PCT/CN2023/132789

§ 371 Date: May 14, 2025

(30) Foreign Application Priority Data
Dec. 28, 2022 (CN) 202211699355.5

(51) Int. Cl. H04W 72/0446; H04B 7/185; H04W 72/12

(52) U.S. Cl. CPC H04W 72/0446; H04B 7/185; H04W 72/12

(57) ABSTRACT

Provided are a signal transmission method, a ground station, a ground terminal and a storage medium. The signal transmission method includes: sending first data according to a sending time (S110); scheduling at least one ground terminal to send second data within the sending time (S120); and receiving the second data according to a receiving time, where the sending time is different from the receiving time (S130).

### TECHNICAL FIELD

The present application relates to the field of wireless communication technology, for example, a signal transmission method, a ground station, a ground terminal and a storage medium.

### BACKGROUND

In conventional satellite communications, since the altitude of a satellite is generally 100 kilometers higher than the ground, the propagation distance between a ground terminal and a base station or a gateway station is as high as hundreds of kilometers, and satellite communications have path propagation delays of more than several milliseconds. Especially, in a high-orbit satellite communication system, the propagation distance is as high as tens of thousands of kilometers, and the path propagation delays reach hundreds of milliseconds. For a Low Earth Orbit (LEO) satellite communication system at an altitude of 600 km, assuming that the latest communication elevation angle is 10 degrees, the value of the round trip time (RTT) between the satellite and the ground terminal ranges from 4 ms to 13 ms. For a Geostationary Earth Orbit (GEO) satellite communication system, the RTT value exceeds 200 ms. The RTT of a terrestrial cellular network is generally kept within 1 ms. In such a scenario, if satellite communications employ a time-division duplex (TDD) transmission mode, both a transmitter and a receiver cannot perform sending and reception simultaneously, thereby resulting in an unlimited channel idle period and a reduced system capacity. If satellite communications employ frequency-division duplex (FDD) transmission mode, especially in a system employing a bent-pipe repeater satellite, with the use of high-frequency spectra, a ground terminal uses an antenna array for signal sending and reception. Because of the large difference between the sending frequency and the receiving frequency, the transceiver antenna arrays of the ground terminal cannot be the same antenna array, and thus the ground terminal needs to be equipped with two antenna arrays, thereby resulting in a larger overall size of the ground terminal and increasing manufacturing costs.

### SUMMARY

Embodiments of the present application provide a signal transmission method, a ground station, a ground terminal and a storage medium to achieve system capacity improvement in a satellite communication scenario, reduce spectrum occupation, lower volume limitation of the transceiver antenna on the ground terminal, and decrease manufacturing costs of the ground terminal.

An embodiment of the present application provides a signal transmission method. The method includes the following.

First data is sent according to a sending time, at least one ground terminal is scheduled to send second data within the sending time, and the second data is received from the at least one ground terminal according to a receiving time, where the sending time is different from the receiving time.

An embodiment of the present application further provides a signal transmission method. The method includes the following.

Scheduling information is acquired from a ground station, and second data is sent within a sending time according to the scheduling information.

An embodiment of the present application further provides a ground station. The ground station includes one or more processors and a memory.

The memory is configured to store one or more programs. The one or more programs, when executed by the one or more processors, cause the one or more processors to perform the signal transmission method according to any embodiment of the present application.

An embodiment of the present application further provides a ground terminal. The ground terminal includes one or more processors and a memory.

The memory is configured to store one or more programs. The one or more programs, when executed by the one or more processors, cause the one or more processors to perform the signal transmission method according to any embodiment of the present application.

An embodiment of the present application further provides a computer-readable storage medium. The computer-readable storage medium is configured to store one or more programs which, when executed by one or more processors, cause the one or more processors to perform the signal transmission method according to any embodiment of the present application.

### BRIEF DESCRIPTION OF DRAWINGS

FIG. 1 is a schematic diagram of satellite communications according to an embodiment of the present application;

FIG. 2 is a flowchart of a signal transmission method according to an embodiment of the present application;

FIG. 3 is a flowchart of another signal transmission method according to an embodiment of the present application;

FIG. 4 is a flowchart of another signal transmission method according to an embodiment of the present application;

FIG. 5 is a schematic diagram of a satellite communication system according to an embodiment of the present application;

FIG. 6 is an example diagram of another signal transmission method according to an embodiment of the present application;

FIG. 7 is a schematic diagram of another satellite communication system according to an embodiment of the present application;

FIG. 8 is a schematic diagram of another satellite communication system according to an embodiment of the present application;

FIG. 9 is an example diagram of another signal transmission method according to an embodiment of the present application;

FIG. 10 is a schematic diagram of another satellite communication system according to an embodiment of the present application;

FIG. 11 is a schematic diagram of another satellite communication system according to an embodiment of the present application;

FIG. 12 is a structure diagram of a signal transmission apparatus according to an embodiment of the present application;

FIG. 13 is a structure diagram of another signal transmission apparatus according to an embodiment of the present application;

FIG. 14 is a structure diagram of a ground station according to an embodiment of the present application; and

FIG. 15 is a structure diagram of a ground terminal according to an embodiment of the present application.

### DETAILED DESCRIPTION

The embodiments described herein are intended to explain the present application.

Suffixes such as “module”, “part” or “unit” used to indicate elements in the subsequent description are merely used to facilitate the description of the present application and have no particular meaning in themselves. Therefore, “module”, “part” or “unit” may be mixed.

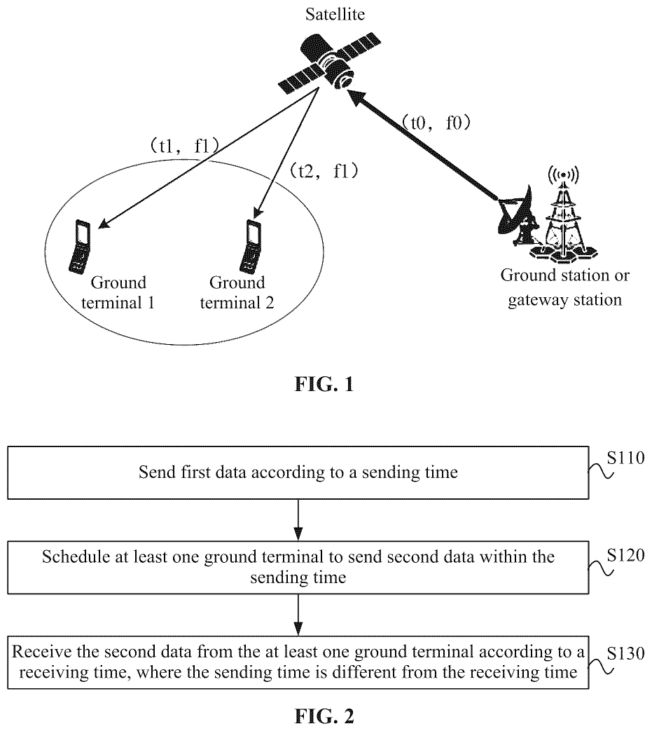

FIG. 1 is a schematic diagram of satellite communications according to an embodiment of the present application. Referring to FIG. 1, in the bent-pipe forwarding mode, satellite communications employ the TDD transmission mode, and a ground station or a gateway station sends a data packet. The propagation link through which the data packet arrives at a satellite from the ground station or the gateway station is called link 0, the carrier frequency used is f0, and the path propagation time is t0. The transmission paths through which the data packet arrives at the ground terminal 1 and the ground terminal 2 from the satellite are called link 1 and link 2, respectively, the propagation delays are t1 and t2, respectively, where t1 is larger than t2, and the carrier frequency used is f1. Due to the long propagation distance, t0, t1, and t2 are generally of the order of millimeters or above. In the TDD mode, after the data packet arrives at the satellite, the link 0 remains idle, and no signal is transmitted over the link 0 for a period of time of at least 2*t1. Such a transmission manner causes a reduction in the system capacity in satellite communications. The embodiments of the present application provide a signal transmission method, in which through asynchronous transceiving, some ground terminals are scheduled to perform uplink sending while other ground terminals perform downlink reception, thereby improving the system capacity in satellite communications.

FIG. 2 is a flowchart of a signal transmission method according to an embodiment of the present application. The embodiment of the present application is applicable to the case of satellite communications. The method may be performed by a signal transmission apparatus. The apparatus may be implemented by software and/or hardware and may generally be integrated into a ground station or a gateway station. Referring to FIG. 2, the method provided by the embodiment of the present application includes S110 to S130.

In S110, first data is sent according to a sending time.

The sending time may be a time configured by the ground station for sending data, and the ground station is only used to send data within the sending time. The first data may be a data packet sent by the ground station. In some embodiments, the first data may carry scheduling information used to schedule a ground terminal.

In the embodiment of the present application, the ground station may send the first data within the sending time.

In S120, at least one ground terminal is scheduled to send second data within the sending time.

The ground terminal may be a terminal device participating in satellite communications, and the ground terminal may acquire a message from the ground station through a satellite. The second data may be data sent by the ground terminal.

In the embodiment of the present application, the ground station may schedule a ground terminal to cause the ground terminal to send the second data to the ground station within the sending time. In some embodiments, the information used to schedule a ground terminal may be sent by the ground station.

In S130, the second data is received from the at least one ground terminal according to a receiving time, where the sending time is different from the receiving time.

The receiving time may be a time configured by the ground station for receiving data, and the ground station is only used to receive data within the receiving time.

In the embodiment of the present application, the ground station receives the second data within the sending time.

In some embodiments, the frequency at which the ground station sends the first data and the frequency at which the ground station receives the second data may be the same or different.

In the embodiment of the present application, the signal transmission method includes: by sending the first data within the sending time, scheduling at least one ground terminal to send the second data within the sending time, and receiving the second data according to the receiving time, in such a manner, the signal transmission in the satellite communication scenario is achieved so that different ground terminals perform data sending or data receiving within the same time, thereby improving the system capacity and enhancing data transmission efficiency.

In some embodiments of the present application, the first data carries scheduling information used to schedule a ground terminal.

In the embodiment of the present application, the ground station sends the first data within the sending time, the first data received by the ground terminal may include scheduling information used to schedule a ground terminal, and the scheduling information may schedule at least one ground terminal to send the second data within the sending time.

In some embodiments of the present application, the time interval between the sending time and the receiving time is at least greater than a mode switch threshold.

The mode switch threshold may be the minimum length of time for the ground station to switch from the sending mode to the receiving mode.

In the embodiment of the present application, a time interval exists between the sending time and the receiving time of the ground station, and the time interval is at least larger than the mode switch threshold to prevent the signal sending and the signal receiving of the ground station from interfering with each other.

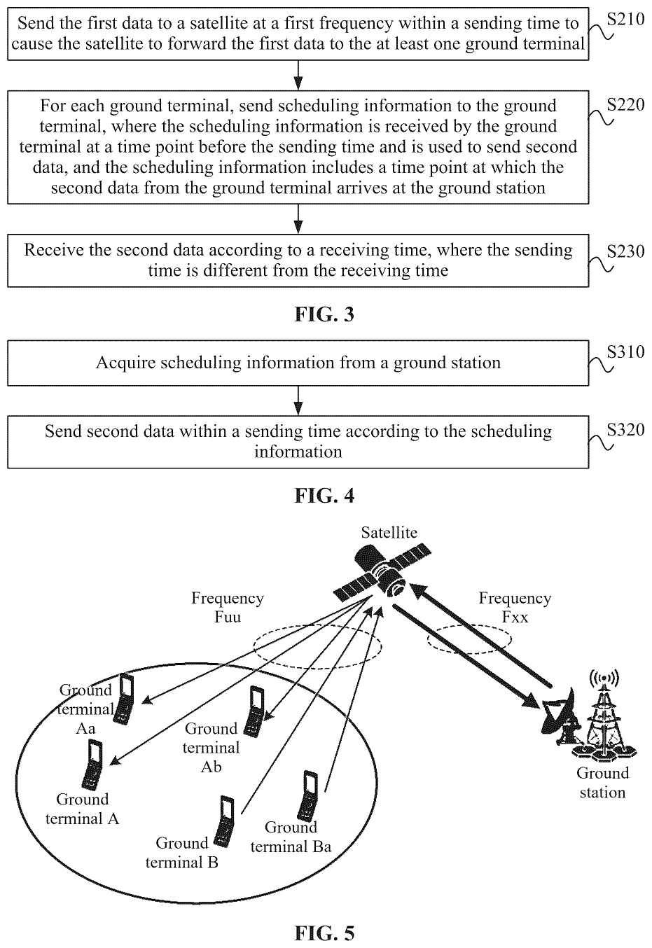

FIG. 3 is a flowchart of another signal transmission method according to an embodiment of the present application. The embodiment of the present application is described based on the preceding embodiments of the present application. Referring to FIG. 3, the method provided in the embodiment of the present application includes S210 to S230.

In S210, first data is sent to a satellite at a first frequency within a sending time to cause the satellite to forward the first data to at least one ground terminal.

In the embodiment of the present application, the ground station may send the first data to the satellite at the first frequency within the sending time to cause the satellite to forward the first data to the ground terminal.

In S220, for each ground terminal, scheduling information is sent to the ground terminal, where the scheduling information is received by the ground terminal at a time point before the sending time and is used to send second data, and the scheduling information includes a time point at which the second data from the ground terminal arrives at the ground station.

The scheduling information may be information used to schedule the ground terminal to send the second data within the sending time, and the scheduling information may include the time point at which the second data from the ground terminal arrives at the ground station. In some embodiments of the present application, the scheduling information may be sent from the ground station to the ground terminal, and the time point may be earlier than the sending time used to send the second data.

In the embodiment of the present application, the ground station may send the scheduling information to at least one ground terminal, and the ground terminal may determine the sending time according to the scheduling information and send the second data according to the sending time.

In S230, second data is received according to a receiving time, where the sending time is different from the receiving time.

In some embodiments of the present application, the sending time or the time point at which the second data from the ground terminal arrives at the ground station is determined by the ground station.

In the embodiment of the present application, the sending time may be determined by the ground station or the time point at which the second data from the ground terminal arrives at the ground station may be determined by the ground station.

In some embodiments of the present application, the sending time or the time point at which the second data from the ground terminal arrives at the ground station is determined by the ground terminal based on a notification message, satellite ephemeris information, a ground terminal location, and a ground station location.

In the embodiment of the present application, the sending time or the time point at which the second data from the ground terminal arrives at the ground station may be determined based on the notification message, the satellite ephemeris information, the ground terminal location, and the ground station location together.

In some embodiments of the present application, the first frequency used to send the first data and a second frequency used to receive the second data have the same value.

In the embodiment of the present application, the frequency value employed by the ground station to send the first data and the frequency value employed by the ground station to send the second data may be the same.

In some embodiments of the present application, the ground station is located on at least one of the satellite or the ground.

The ground station may be located on the satellite or the ground. When the ground station is located on the satellite, the communication time between the ground station and the satellite may be shortened, thereby reducing the transmission delay in satellite communications.

In some embodiments of the present application, the operation where at least one ground terminal is scheduled to send the second data within the sending time includes at least one of the following operations.

Different ground terminals are scheduled to send the second data within the same sending time; different ground terminals are scheduled to send the second data within different sending times; or the second data from different ground terminals is scheduled to arrive at the ground station within the same time point.

In the embodiment of the present application, how the ground station schedules the ground terminal to send the second data may be flexible. The first data carrying the scheduling information and received by different ground terminals may be the same, and one or more ground terminals may send the second data to the ground station within the same sending time. In other embodiments of the present application, the first data carrying the scheduling information and received by different ground terminals may be different, and one or more ground terminals may send the second data to the ground station within different sending times. In other embodiments of the present application, the ground station may schedule the second data (which is from the ground terminal within the sending time) to arrive at the ground station within the same time point.

In other embodiments of the present application, the duration of a data block of the second data is determined by the ground station.

In the embodiment of the present application, the ground station may control the duration of the data block of the second data by scheduling the duration during which the ground terminal sends the second data.

FIG. 4 is a flowchart of another signal transmission method according to an embodiment of the present application. The embodiment of the present application is applicable to the case of satellite communications. The method may be performed by a signal transmission apparatus. The apparatus may be implemented by software and/or hardware and may generally be integrated into a ground terminal. Referring to FIG. 4, the method provided by the embodiment of the present application includes S310 to S320.

In S310, scheduling information is acquired from a ground station.

The scheduling information may be information for a ground station to schedule a ground terminal to send second data.

In the embodiment of the present application, the ground terminal may receive the scheduling information from the ground station, and the scheduling information may be used to schedule the ground terminal to send the second data. In some embodiments of the present application, the scheduling information may be carried in first data sent by the ground station.

In S320, second data is sent within a sending time according to the scheduling information.

In the embodiment of the present application, the ground terminal may send the second data within the sending time according to the scheduling information.

In some embodiments of the present application, the scheduling information is carried in the first data sent by the ground station within the sending time.

In the embodiment of the present application, the ground station carries the scheduling information in the first data sent within the sending time and schedules at least one ground terminal to send the second data within the sending time through the scheduling information.

In some embodiments of the present application, the sending time or the time point at which the second data from the ground terminal arrives at the ground station is determined by the ground station.

In other embodiments of the present application, the sending time or the time point at which the second data from the ground terminal arrives at the ground station is determined by the ground terminal based on a notification message, satellite ephemeris information, a ground terminal location, and a ground station location.

In some embodiments of the present application, the operation where the second data is sent within the sending time according to the scheduling information includes the following operation.

The second data is sent to a satellite according to the sending time in the scheduling information to cause the satellite to forward the second data to the ground station.

In the embodiment of the present application, the ground terminal may send the second data to the satellite according to the sending time carried in the scheduling information to cause the satellite to forward the second data to the ground station.

In other embodiments of the present application, the operation where the second data is sent within the sending time according to the scheduling information includes the following operation.

The second data is sent according to a notification message to cause the second data to arrive at the ground station according to the time point, where the notification message is in the scheduling information and is used to indicate the time point at which the second data from the ground terminal arrives at the ground station.

In the embodiment of the present application, the ground terminal may send the second data at the time point indicated by the notification message in the scheduling information to cause the second data to arrive at the ground station at the time point.

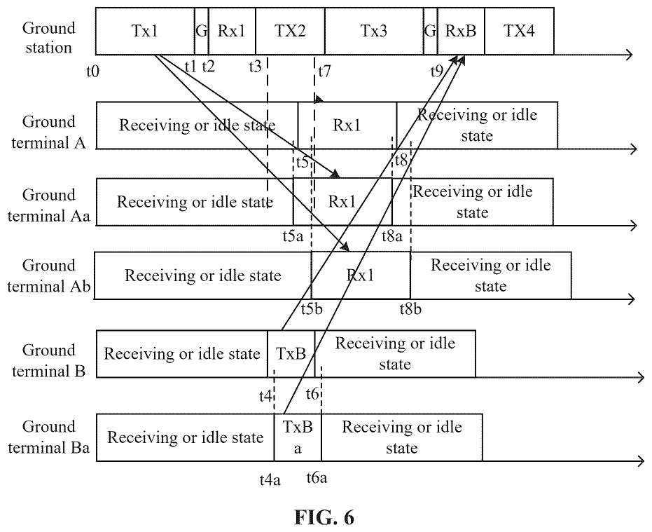

In an example embodiment, FIG. 5 is a schematic diagram of a satellite communication system according to an embodiment of the present application. Referring to FIG. 5, in the satellite communication system, the satellite is a bent-pipe repeater satellite, the ground terminals are located in the same cell under the coverage of the satellite, and the ground station is located on the ground. The frequency Fxx is used for data sending and data receiving between the ground station and the satellite, and the frequency Fuu is used for data sending and data receiving between the ground terminals and the satellite. The ground terminals employ an asynchronous transceiving mode and may only perform either reception or sending at the same time point. Similarly, the ground station may also employ the asynchronous transceiving mode like the ground terminals and only perform either reception or sending at the same time point. The ground station may schedule some ground terminals to send data while sending data. After the ground station completes data sending, the ground station may switch from the sending mode to the receiving mode. The second data from the ground terminals arrives at the ground station within a certain time after the ground station completes data sending. The data transmission manner in this case is shown in FIG. 6:

During the time period from t0 to t1, the ground station is in the sending mode and sends data; during the time period from t1 to t2, the ground station switches to the receiving mode, but no data arrives at the ground station; during the time period from t2 to t3, the ground station is in the receiving mode, and data arrives at the ground station; during the time period from t3 to t7, the ground station is in the sending mode and sends data; the above cycle repeats. During each sending period, data is sent to multiple users; during each receiving period, data is received from multiple ground terminals.

The ground terminal A is in the receiving mode or the idle mode for most of the time and receives the data Tx1 sent by the ground station at the time point t5.

The ground terminal Aa is in the receiving mode or the idle mode for most of the time, and since the propagation distance between the ground terminal Aa and the ground station is smaller than the propagation distance between the ground terminal A and the ground station, the ground terminal Aa receives the data Tx1 from the ground station at the time point t5a before t5.

The ground terminal Ab is in the receiving mode or the idle mode for most of the time, and since the propagation distance between the ground terminal Ab and the ground station is larger than the propagation distance between the ground terminal A and the ground station, the ground terminal Ab receives the data Tx1 from the ground station at the time point t5b after t5.

The ground terminal B is in the receiving mode or the idle mode for most of the time. At the time point t4, the ground terminal B starts the sending mode and sends data to the ground station, where the time point t4 is determined by the ground station and the ground station notifies the ground terminal B by sending data within a sending period before the time point t4. At the time point t9, the ground station receives the data from the ground terminal B. The time point t4 may also be determined by the ground terminal B according to the notification information received from the ground station and information such as the path propagation time of information between the ground station and the ground terminal B, including the satellite forwarding processing time, and the data sent at the determined time point t4 needs to arrive at the ground station at the time point t9.

The ground terminal Ba is in the receiving mode or the idle mode for most of the time. At the time point t4a, the ground terminal Ba starts the sending mode and sends data to the ground station, where the time point t4a is determined by the ground station and the ground station notifies the ground terminal Ba by sending data within a sending period before the time point t4a. At the time point t9, the ground station receives the data from the ground terminal Ba. The time point t4a may also be determined by the ground terminal Ba according to the notification information received from the ground station and information such as the path propagation time of information between the ground station and the ground terminal Ba, including the satellite forwarding processing time, and the data sent at the determined time point t4a needs to arrive at the ground station at the time point t9.

In FIG. 6, during the time period from t4 to t8b, the ground terminals A, Aa, and Ab are in the receiving state, and the ground terminals B and Ba are in the sending state, but these five ground terminals are in only one state at the same time point. The ground station is only in one state at the same time point, and G represents one guard period and at least includes the time for the ground station to switch from the sending mode to the receiving mode. The sending durations of the ground terminals B and Ba, that is, the time lengths of the data blocks TxB and TxBa, may be the same or different, but the lengths cannot exceed the length of RxB. There is a certain allowable time error between the arrival time of the data block TxB at the ground station and the arrival time of the data block TxBa at the ground station, that is, the arrival time is within the range of t9±Δt, where Δt is the maximum time deviation allowed by the system.

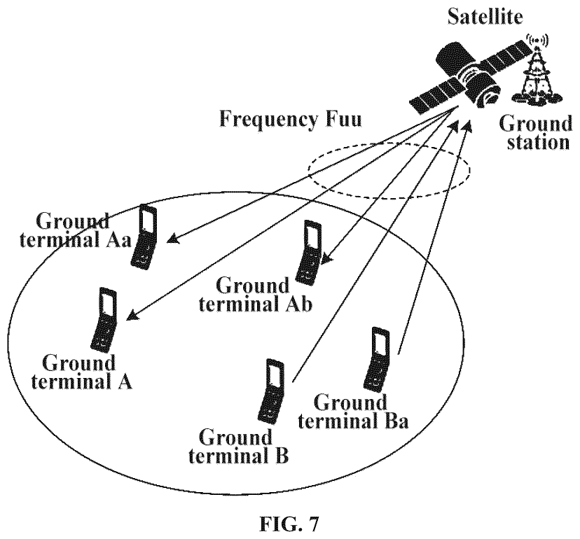

In another example embodiment, referring to FIG. 7, in the satellite communication system, the satellite may have all or part of the functions of the ground station, that is, the ground station is located on the satellite. The transmission path between the ground terminals and the ground station becomes the transmission path between the ground terminals and the satellite, and the satellite may use the frequency Fuu to send and receive data. The transmission process may be as shown in FIG. 6. During the time period from t0 to t1, the ground station is in the sending mode and sends data; during the time period from t1 to t2, the ground station switches to the receiving mode, but no data arrives at the ground station; during the time period from t2 to t3, the ground station is in the receiving mode, and data arrives at the ground station; during the time period from t3 to t7, the ground station is in the sending mode and sends data; the above cycle repeats. During each sending period, data is sent to multiple users; during each receiving period, data is received from multiple ground terminals.

The ground terminal A is in the receiving mode or the idle mode for most of the time and receives the data Tx1 from the ground station at the time point t5.

The ground terminal Aa is in the receiving mode or the idle mode for most of the time, and since the propagation distance between the ground terminal Aa and the ground station is smaller than the propagation distance between the ground terminal A and the ground station, the ground terminal Aa receives the data Tx1 from the ground station at the time point t5a before t5.

The ground terminal Ab is in the receiving mode or the idle mode for most of the time, and since the propagation distance between the ground terminal Ab and the ground station is larger than the propagation distance between the ground terminal A and the ground station, the ground terminal Ab receives the data Tx1 from the ground station at the time point t5b after t5.

The ground terminal B is in the receiving mode or the idle mode for most of the time. At the time point t4, the ground terminal B starts the sending mode and sends data to the ground station, where the time point t4 is determined by the ground station and the ground station notifies the ground terminal B by sending data within a sending period before the time point t4. At the time point t9, the ground station receives the data from the ground terminal B. The time point t4 may also be determined by the ground terminal B according to the notification information received from the ground station and information such as the path propagation time of information between the ground station and the ground terminal B, including the satellite forwarding processing time, and the data sent at the determined time point t4 needs to arrive at the ground station at the time point t9.

The ground terminal Ba is in the receiving mode or the idle mode for most of the time. At the time point t4a, the ground terminal Ba starts the sending mode and sends data to the ground station, where the time point t4a is determined by the ground station and the ground station notifies the ground terminal Ba by sending data within a sending period before the time point t4a. At the time point t9, the ground station receives the data from the ground terminal Ba. The time point t4a may also be determined by the ground terminal Ba according to the notification information received from the ground station and information such as the path propagation time of information between the ground station and the ground terminal Ba, including the satellite forwarding processing time, and the data sent at the determined time point t4a needs to arrive at the ground station at the time point t9.

In FIG. 6, during the time period from t4 to t8b, the ground terminals A, Aa, and Ab are in the receiving state, and the ground terminals B and Ba are in the sending state, but these five ground terminals are in only one state at the same time point. The ground station is only in one state at the same time point, and G represents one guard period and at least includes the time for the ground station to switch from the sending mode to the receiving mode. The sending durations of the ground terminals B and Ba, that is, the time lengths of the data blocks TxB and TxBa, may be the same or different, but the lengths cannot exceed the length of RxB. There is a certain allowable time error between the arrival time of the data block TxB at the ground station and the arrival time of the data block TxBa at the ground station, that is, the arrival time is within the range of t9±Δt, where Δt is the maximum time deviation allowed by the system.

In the embodiment of the present application, since the ground station is located on the satellite, the path propagation delay is reduced, and the duration of each transmit block can be correspondingly reduced, thereby reducing transceiving collisions on the ground station on the satellite.

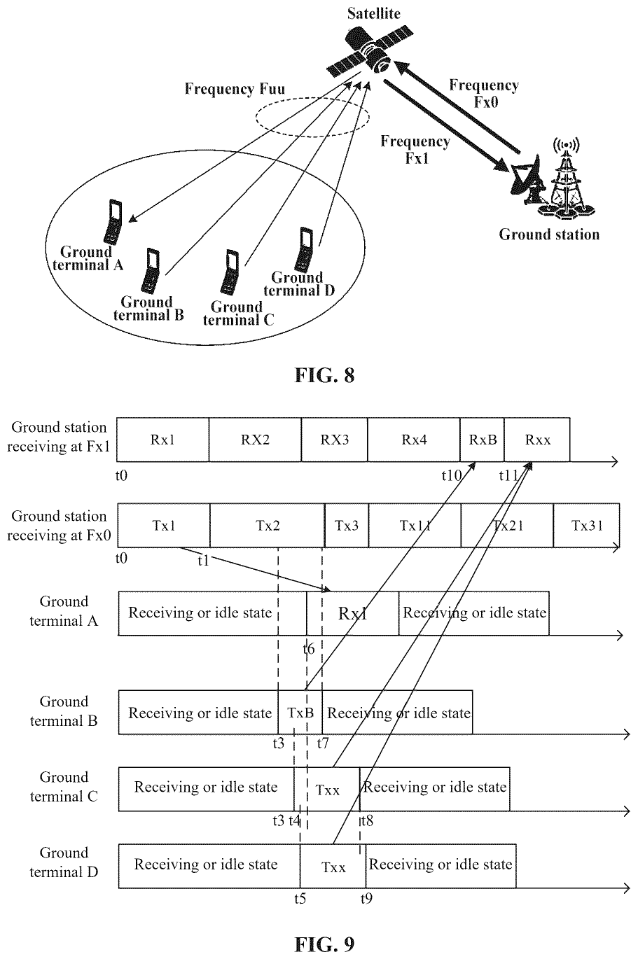

In an example embodiment, FIG. 8 is a schematic diagram of another satellite communication system according to an embodiment of the present application. Referring to FIG. 8, in the satellite communication system, the satellite is a bent-pipe repeater satellite, the ground terminals are located in the same cell under the coverage of the satellite, and the ground station is located on the ground. The ground station uses the frequency Fx0 to send signals to the satellite, and the satellite uses the frequency Fx1 to send signals to the ground station. The ground station uses different frequencies to perform sending and reception simultaneously, and the frequency Fuu is used for data sending and data receiving between the ground terminals and the satellite. The ground terminals employ an asynchronous transceiving mode and may only perform either reception or sending at the same time point. The ground station schedules some ground terminals in a non-receiving mode to send data while sending data. The timing relationships of data transmission in this scenario are shown in FIG. 9. During the time period from t0 to t1, the ground station sends data. The ground terminal A is in the receiving mode or the idle mode for most of the time and receives the data Tx1 from the ground station at the time point t6. The ground terminal B is in the receiving mode or the idle mode for most of the time. At the time point t3, the ground terminal B starts the sending mode and sends data to the ground station, where the time point t3 is determined by the ground station and the ground station notifies the ground terminal B by sending data before the time point t3. At the time point t10, the ground station receives the data from the ground terminal B. The time point t3 may also be determined by the ground terminal B according to the notification information received from the ground station and information such as the propagation time of information between the ground station and the ground terminal B, including the satellite forwarding processing time, and the data sent at the determined time point t3 needs to arrive at the ground station at the time point t10.

The ground terminal C is in the receiving mode or the idle mode for most of the time. At the time point t4, the ground terminal C starts the sending mode and sends data to the ground station, where the time point t4 is determined by the ground station and the ground station notifies the ground terminal C by sending data before the time point t4. At the time point t11, the ground station receives the data from the ground terminal C. The time point t4 may also be determined by the ground terminal C according to the notification information received from the ground station and information such as the propagation time of information between the ground station and the ground terminal C, including the satellite forwarding processing time, and the data sent at the determined time point t4 needs to arrive at the ground station at the time point t11.

The ground terminal D is in the receiving mode or the idle mode for most of the time. At the time point t5, the ground terminal D starts the sending mode and sends data to the ground station, where the time point t5 is determined by the ground station and the ground station notifies the ground terminal D by sending data before the time point t5. At the time point t11, the ground station receives the data from the ground terminal D. The time point t5 may also be determined by the ground terminal D according to the notification information received from the ground station and information such as the propagation time of information between the ground station and the ground terminal D, including the satellite forwarding processing time, and the data sent at the determined time point t5 needs to arrive at the ground station at the time point t11.

The duration of each sent data block of the ground station is flexible, and the durations of different sent data blocks may be fixed or different. Similarly, the duration of each received data block of the ground station is flexible, and the durations of different received data blocks may be fixed or different. The duration of the data block from the ground terminal is determined by the ground station. When the data from different ground terminals arrives at the ground station within the same receiving period, their arrival times may be deviated.

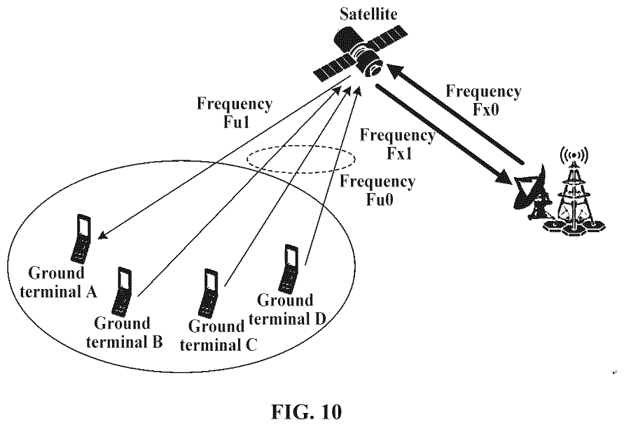

In an example embodiment, FIG. 10 is a schematic diagram of another satellite communication system according to an embodiment of the present application. Referring to FIG. 10, in the satellite communication system, the satellite is a bent-pipe repeater satellite, the ground terminals are located in the same cell under the coverage of the satellite, and the ground station is located on the ground. The ground station uses the frequency Fx0 to send signals to the satellite, and the satellite uses the frequency Fx1 to send signals to the ground station. The ground station uses different frequencies to perform sending and reception simultaneously. The ground terminals use the frequency Fu0 to send signals to the satellite, and the satellite uses the frequency Ful to send signals to the ground terminals. The ground terminals employ an asynchronous transceiving mode and may only perform either reception or sending at the same time point. The ground station schedules some ground terminals in a non-receiving mode to send data while sending data. During the time period from t0 to t1, the ground station sends data. The ground terminal A is in the receiving mode or the idle mode for most of the time and receives the data Tx1 from the ground station at the time point t6. The ground terminal B is in the receiving mode or the idle mode for most of the time. At the time point t3, the ground terminal B starts the sending mode and sends data to the ground station, where the time point t3 is determined by the ground station and the ground station notifies the ground terminal B by sending data before the time point t3. At the time point t10, the ground station receives the data from the ground terminal B. The time point t3 may also be determined by the ground terminal B according to the notification information received from the ground station and information such as the propagation time of information between the ground station and the ground terminal B, including the satellite forwarding processing time, and the data sent at the determined time point t3 needs to arrive at the ground station at the time point t10.

The ground terminal C is in the receiving mode or the idle mode for most of the time. At the time point t4, the ground terminal C starts the sending mode and sends data to the ground station, where the time point t4 is determined by the ground station and the ground station notifies the ground terminal C by sending data before the time point t4. At the time point t11, the ground station receives the data from the ground terminal C. The time point t4 may also be determined by the ground terminal C according to the notification information received from the ground station and information such as the propagation time of information between the ground station and the ground terminal C, including the satellite forwarding processing time, and the data sent at the determined time point t4 needs to arrive at the ground station at the time point t11.

The ground terminal D is in the receiving mode or the idle mode for most of the time. At the time point t5, the ground terminal D starts the sending mode and sends data to the ground station, where the time point t5 is determined by the ground station and the ground station notifies the ground terminal D by sending data before the time point t5. At the time point t11, the ground station receives the data from the ground terminal D. The time point t5 may also be determined by the ground terminal D according to the notification information received from the ground station and information such as the propagation time of information between the ground station and the ground terminal D, including the satellite forwarding processing time, and the data sent at the determined time point t5 needs to arrive at the ground station at the time point t11.

The duration of each sent data block of the ground station is flexible, and the durations of different sent data blocks may be fixed or different. Similarly, the duration of each received data block of the ground station is flexible, and the durations of different received data blocks may be fixed or different. The duration of the data block from the ground terminal is determined by the ground station. When the data from different ground terminals arrives at the ground station within the same receiving period, their arrival times may be deviated. In the embodiment of the present application, the ground terminals may use different frequencies to send data and receive data.

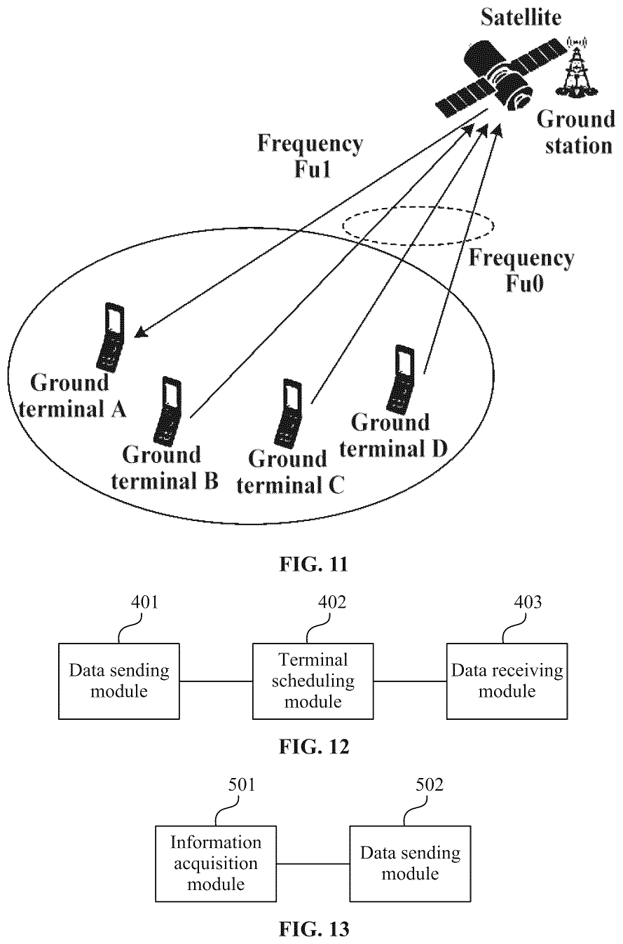

In another example embodiment, FIG. 11 is a schematic diagram of another satellite communication system according to an embodiment of the present application. Referring to FIG. 11, in the satellite communication system provided by the embodiment of the present application, the satellite has all or part of the functions of the ground station, that is, the ground station is located on the satellite. The information transmission path between the ground terminals and the ground station becomes the transmission path between the ground terminals and the satellite. The ground terminals use the frequency Fu0 to send signals to the satellite, and the satellite uses the frequency Fu1 to send signals to the ground terminals. The ground terminals employ an asynchronous transceiving mode and may only perform either reception or sending at the same time point. The ground station on the satellite may perform sending and reception simultaneously by using the frequency Fu1 and the frequency Fu0, respectively. The ground station schedules some ground terminals in a non-receiving mode to send data while sending data to other ground terminals. The data timing in the signal transmission process is as follows:

During the time period from t0 to t1, the ground station sends data. The ground terminal A is in the receiving mode or the idle mode for most of the time and receives the data Tx1 from the ground station at the time point t6. The ground terminal B is in the receiving mode or the idle mode for most of the time. At the time point t3, the ground terminal B starts the sending mode and sends data to the ground station, where the time point t3 is determined by the ground station and the ground station notifies the ground terminal B by sending data before the time point t3. At the time point t10, the ground station receives the data from the ground terminal B. The time point t3 may also be determined by the ground terminal B according to the notification information received from the ground station and information such as the propagation time of information between the ground station and the ground terminal B, including the satellite forwarding processing time, and the data sent at the determined time point t3 needs to arrive at the ground station at the time point t10.

The ground terminal C is in the receiving mode or the idle mode for most of the time. At the time point t4, the ground terminal C starts the sending mode and sends data to the ground station, where the time point t4 is determined by the ground station and the ground station notifies the ground terminal C by sending data before the time point t4. At the time point t11, the ground station receives the data from the ground terminal C. The time point t4 may also be determined by the ground terminal C according to the notification information received from the ground station and information such as the propagation time of information between the ground station and the ground terminal C, including the satellite forwarding processing time, and the data sent at the determined time point t4 needs to arrive at the ground station at the time point t11.

The ground terminal D is in the receiving mode or the idle mode for most of the time. At the time point t5, the ground terminal D starts the sending mode and sends data to the ground station, where the time point t5 is determined by the ground station and the ground station notifies the ground terminal D by sending data before the time point t5. At the time point t11, the ground station receives the data from the ground terminal D. The time point t5 may also be determined by the ground terminal D according to the notification information received from the ground station and information such as the propagation time of information between the ground station and the ground terminal D, including the satellite forwarding processing time, and the data sent at the determined time point t5 needs to arrive at the ground station at the time point t11.

FIG. 12 is a structure diagram of a signal transmission apparatus according to an embodiment of the present application. The signal transmission apparatus may perform the signal transmission method provided by any embodiment of the present application and have function modules and effects corresponding to the performed method. The apparatus may be implemented by software and/or hardware and is generally integrated into a ground station or a gateway station. The apparatus includes a data sending module 401, a terminal scheduling module 402, and a data receiving module 403.

The signal sensing module 401 is configured to send first data according to a sending time.

The terminal scheduling module 402 is configured to schedule at least one ground terminal to send second data within the sending time.

The data receiving module 403 is configured to receive the second data according to a receiving time, where the sending time is different from the receiving time.

In some embodiments of the present application, in the apparatus, the first data carries scheduling information used to schedule a ground terminal.

In other embodiments of the present application, the time interval between the sending time and the receiving time is at least greater than a mode switch threshold.

In some embodiments of the present application, the data sending module 401 is configured to send the first data to a satellite at a first frequency within the sending time to cause the satellite to forward the first data to the at least one ground terminal.

In other embodiments of the present application, the terminal scheduling module 402 is configured to schedule the ground terminal to send the second data according to the sending time carried in the first data or a notification message, where the notification message is used to indicate a time point at which the second data from the ground terminal arrives at the ground station.

In some embodiments of the present application, the sending time or the time point at which the second data from the ground terminal arrives at the ground station is determined by the ground station.

In other embodiments of the present application, the sending time or the time point at which the second data from the ground terminal arrives at the ground station is determined by the ground terminal based on the notification message, satellite ephemeris information, a ground terminal location, and a ground station location.

In some embodiments of the present application, the first frequency used to send the first data, and a second frequency used to receive the second data have the same value.

In some embodiments of the present application, the terminal scheduling module 402 is further configured to perform at least one of the following operations.

Different ground terminals are scheduled to send the second data within the same sending time; different ground terminals are scheduled to send the second data within different sending times; the second data from different ground terminals is scheduled to arrive at the ground station at the same time point; or the second data from different ground terminals is scheduled to arrive at the ground station at different time points.

In some other embodiments of the present application, the durations of data blocks of the first data are different.

In some other embodiments of the present application, the duration of a data block of the second data is determined by the ground station.

FIG. 13 is a structure diagram of a signal transmission apparatus according to an embodiment of the present application. The signal transmission apparatus may perform the signal transmission method provided by any embodiment of the present application and have function modules and effects corresponding to the performed method. The apparatus may be implemented by software and/or hardware and is generally integrated into a ground terminal. The apparatus includes an information acquisition module 501 and a data sending module 502.

The information acquisition module 501 is configured to acquire scheduling information from a ground station.

The signal sensing module 502 is configured to send second data within a sending time according to the scheduling information.

In some embodiments of the present application, the scheduling information includes at least one of: the sending time or a notification message indicating a time point at which the second data from the ground terminal arrives at the ground station.

In other embodiments of the present application, the scheduling information is carried in the first data from the ground station within the sending time.

In some embodiments of the present application, the sending time or the time point at which the second data from the ground terminal arrives at the ground station is determined by the ground station.

In other embodiments of the present application, the sending time or the time point at which the second data from the ground terminal arrives at the ground station is determined by the ground terminal based on the notification message, satellite ephemeris information, a ground terminal location, and a ground station location.

In some embodiments of the present application, the data sending module 502 is configured to send the second data to a satellite according to the sending time in the scheduling information to cause the satellite to forward the second data to the ground station.

In other embodiments of the present application, the data sending module 502 is configured to send second data according to a notification message indicating a time point at which the second data from the ground terminal arrives at the ground station included in the scheduling information to cause the second data to arrive at the ground station according to the time point at which the second data from the ground terminal arrives at the ground station.

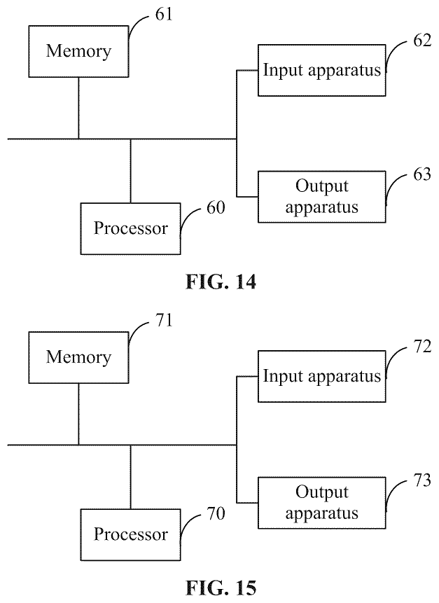

FIG. 14 is a structure diagram of a ground station according to an embodiment of the present application. The ground station includes a processor 60, a memory 61, an input apparatus 62, and an output apparatus 63. One or more processors 60 may be included in the ground station. One processor 60 is shown as an example in FIG. 14. The processor 60, the memory 61, the input apparatus 62, and the output apparatus 63 in the ground station may be connected via a bus or in other manners. The connection via a bus is shown as an example in FIG. 14.

As a computer-readable storage medium, the memory 61 may be configured to store software programs and computer-executable programs and modules, for example, modules (the data sending module 401, the terminal scheduling module 402, and the data receiving module 403) corresponding to the signal transmission apparatus in the embodiments of the present application. The processor 60 runs the software programs, instructions, and modules stored in the memory 61 to perform function applications and data processing of the ground station, that is, the preceding signal transmission method is implemented.

The memory 61 may mainly include a program storage region and a data storage region, where the program storage region may store an operating system and an application program required by at least one function, and the data storage region may store data created according to the use of the ground station. Additionally, the memory 61 may include a high-speed random-access memory and may also include a nonvolatile memory such as at least one magnetic disk memory, a flash memory, or another nonvolatile solid-state memory. In some examples, the memory 61 may include memories that are remotely disposed with respect to the processor 60. These remote memories may be connected to the ground station via a network. Examples of the preceding network include, but are not limited to, the Internet, an intranet, a local area network, a mobile communication network, and a combination thereof.

The input apparatus 62 may be configured to receive inputted digital or character information and generate key signal input related to user settings and function control of the ground station. The output apparatus 63 may include a display device such as a display screen.

FIG. 15 is a structure diagram of a ground terminal according to an embodiment of the present application. The ground terminal includes a processor 70, a memory 71, an input apparatus 72, and an output apparatus 73. One or more processors 70 may be included in the ground terminal. One processor 70 is shown as an example in FIG. 15. The processor 70, the memory 71, the input apparatus 72, and the output apparatus 73 in the ground terminal may be connected via a bus or in other manners. The connection via a bus is shown as an example in FIG. 15.

As a computer-readable storage medium, the memory 71 may be configured to store software programs and computer-executable programs and modules, for example, modules (the information acquisition module 501 and the data sending module 502) corresponding to the signal transmission apparatus in the embodiments of the present application. The processor 70 runs the software programs, instructions, and modules stored in the memory 71 to perform function applications and data processing of the ground terminal, that is, the preceding signal transmission method is implemented.

The memory 71 may include a program storage region and a data storage region, where the program storage region may store an operating system and an application program required by at least one function, and the data storage region may store data created according to the use of the ground terminal. Additionally, the memory 71 may include a high-speed random-access memory and may also include a nonvolatile memory such as at least one magnetic disk memory, a flash memory, or another nonvolatile solid-state memory. In some examples, the memory 71 may include memories that are remotely disposed with respect to the processor 70. These remote memories may be connected to the ground terminal via a network. Examples of the preceding network include, but are not limited to, the Internet, an intranet, a local area network, a mobile communication network, and a combination thereof.

The input apparatus 72 may be configured to receive inputted digital or character information and generate key signal input related to user settings and function control of the ground terminal. The output apparatus 73 may include a display device such as a display screen.

An embodiment of the present application further provides a storage medium including computer-executable instructions which, when executed by a computer processor, cause the computer processor to perform the signal transmission method. The method includes the following operations.

First data is sent according to a sending time, at least one ground terminal is scheduled to send second data within the sending time, and the second data is received according to a receiving time, where the sending time is different from the receiving time; or scheduling information is acquired from a ground station, and second data is sent within a sending time according to the scheduling information.

From the preceding description of embodiments, it is apparent to those skilled in the art that the present application may be implemented by software and necessary general-purpose hardware or may be implemented by hardware, and the former is a preferred implementation in many cases. Based on the above understanding, the solutions of the present application may substantially be embodied in the form of a software product. The computer software product may be stored in a computer-readable storage medium such as a floppy disk, a read-only memory (ROM), a random-access memory (RAM), a flash memory, a hard disk, or an optical disk of a computer and includes several instructions for causing a computer device (which may be a personal computer, a server or a network device) to perform the methods in the embodiments of the present application.

Units and modules included in the embodiments of the preceding apparatus are divided according to functional logic, and the division is not limited to this as long as the corresponding functions can be implemented. Additionally, the names of function units are intended to distinguish between each other and are not to limit the scope of the present application.

It is to be understood by those of ordinary skill in the art in the art that some or all operations of the preceding method and function modules/units in the preceding system or device are implementable as software, firmware, hardware, and suitable combinations thereof.

In the hardware implementation, the division of the functional modules/units mentioned in the above description may not correspond to the division of physical components. For example, one physical component may have multiple functions or one function or operation may be executed jointly by several physical components. Some or all physical components may be implemented as software executed by a processor such as a central processing unit, a digital signal processor, or a microprocessor, may be implemented as hardware, or may be implemented as integrated circuits such as application-specific integrated circuits. Such software may be distributed on computer-readable media. The computer-readable media may include computer storage media (or non-transitory media) and communication media (or transitory media). As is known to those of ordinary skill in the art, the term computer storage media includes volatile and nonvolatile media as well as removable and non-removable media implemented in any method or technology for storing information (such as computer-readable instructions, data structures, program modules or other data). The computer storage media include, but are not limited to, a random-access memory (RAM), a read-only memory (ROM), an electrically erasable programmable read-only memory (EEPROM), a flash memory or other memory technologies, a compact disc read-only memory (CD-ROM), a digital versatile disc (DVD) or other optical disc storages, a magnetic cassette, a magnetic tape, a magnetic disk or other magnetic storage devices or any other medium that can be used to store desired information and can be accessed by a computer. Additionally, as is known to those of ordinary skill in the art, the communication media generally include computer readable instructions, data structures, program modules, or other data in a modulated data signal such as a carrier wave or other transport mechanism and include any information delivery media.

1. A signal transmission method, applied to a ground station and comprising:
sending first data according to a sending time;
scheduling at least one ground terminal to send second data within the sending time; and
receiving the second data from the at least one ground terminal according to a receiving time, wherein the sending time is different from the receiving time.

2. The method of claim 1, wherein the first data carries scheduling information used to schedule the at least one ground terminal.

3. The method of claim 1, wherein a time interval between the sending time and the receiving time is at least greater than a mode transition threshold.

4. The method of claim 1, wherein sending the first data according to the sending time comprises:
sending the first data to a satellite at a first frequency within the sending time to cause the satellite to forward the first data to the at least one ground terminal.

5. The method of claim 1, wherein scheduling the at least one ground terminal to send the second data within the sending time comprises:
for each of the at least one ground terminal, sending scheduling information to the ground terminal, wherein the scheduling information is received by the ground terminal at a time point before the sending time and is used to send the second data, and the scheduling information comprises a time point at which the second data from the ground terminal arrives at the ground station.

6. The method of claim 5, wherein the sending time or the time point at which the second data from the ground terminal arrives at the ground station is determined by the ground station.

7. The method of claim 5, wherein the sending time or the time point at which the second data from the ground terminal arrives at the ground station is determined by the ground terminal based on a notification message, satellite ephemeris information, a ground terminal location and a ground station location.

8. The method of claim 1, wherein the first frequency used to send the first data and a second frequency used to receive the second data have a same value.

9. The method of claim 1, wherein the ground station is located on at least one of a satellite or a ground.

10. The method of claim 1, wherein scheduling the at least one ground terminal to send the second data within the sending time comprises at least one of:
scheduling different ground terminals to send the second data within a same sending time;
scheduling different ground terminals to send the second data within different sending times; or
scheduling the second data from different ground terminals to arrive at the ground station at a same time point.

11. The method of claim 1, wherein a duration of a data block of the second data is determined by the ground station.

12. A signal transmission method, applied to a ground terminal and comprising:
acquiring scheduling information from a ground station; and
sending second data within a sending time according to the scheduling information.

13. The method of claim 12, wherein the scheduling information comprises at least one of:
the sending time; or
a notification message indicating a time point at which the second data arrives at the ground station.

14. The method of claim 12, wherein the sending time or the time point is determined by the ground station.

15. The method of claim 12, wherein the sending time or the time point is determined by the ground terminal based on a notification message, satellite ephemeris information, a ground terminal location, and a ground station location.

16. The method of claim 12, wherein sending the second data at the sending time according to the scheduling information comprises:
sending the second data to a satellite according to the sending time in the scheduling information to cause the satellite to forward the second data to the ground station.

17. The method of claim 12, wherein sending the second data within the sending time according to the scheduling information comprises:
sending the second data according to a notification message, which is comprised in the scheduling information and is used to indicate a time point at which the second data arrives at the ground station, to cause the second data to arrive at the ground station at the time point.

18. A ground station, comprising:
at least one processor; and
a memory configured to store at least one program;
wherein the at least one program, when executed by the at least one processor, causes the at least one processor to perform:
sending first data according to a sending time;
scheduling at least one ground terminal to send second data within the sending time; and
receiving the second data from the at least one ground terminal according to a receiving time, wherein the sending time is different from the receiving time.

19. A ground terminal, comprising:
at least one processor; and
a memory configured to store at least one program;
wherein the at least one program, when executed by the at least one processor, causes the at least one processor to perform the signal transmission method of claim 12.

20. A non-transitory computer-readable storage medium storing at least one program which, when executed by at least one processor, causes the at least one processor to perform the signal transmission method of any one of claim 1.
